(19) United States
(12) Patent Application Publication
(10) Pub. No.: US 2012/0211318 A1
(43) Pub. Date: Aug. 23, 2012

(54) Real-Time Variable Damping Module Using Magnetic Shape Memory Material

(75) Inventors: Shivaram Ac, Bangalore (IN); Ashish Khandelwal, Bangalore (IN)

(73) Assignee: GM GLOBAL TECHNOLOGY OPERATIONS LLC, Detroit, MI (US)

(21) Appl. No.: 13/029,248

(22) Filed: Feb. 17, 2011

(51) Int. Cl. F16F 9/50

(52) U.S. Cl. 188/283

(57) ABSTRACT

A real-time continuous damping module includes a flow channel that is configured to allow fluid to flow between a first chamber and a second chamber of a cylindrical tubular member when a pressurizing device exerts a pressure on the fluid within the first chamber. A variable damper assembly is configured to control a flow of fluid through the flow channel. The variable damper assembly includes a damper configured to variably obstruct an opening of the flow channel. A magnetic shape memory element is configured to variably control a position of the damper within the opening of the flow channel. The magnetic shape memory element exhibits changes in shape when exposed to a magnetic field. An electromagnetic device regulates the magnetic field for variably controlling the position of the damper within the flow channel by changing the shape of the magnetic shape memory element.

### BACKGROUND OF INVENTION

An embodiment relates generally to real time damping devices within a vehicle.

Vehicles utilize damping devices to control or smooth movement between two members of a vehicle that may produce an oscillation. These damping devices typically are piston-type devices that include two fluid filled chambers that control motion or oscillation by transferring fluid between chambers utilizing hydraulic gates and valves. Damping is often controlled by regulating a resistance of the fluid flow between the piston chambers. Typically such piston-type devices utilize flow channels having a set size to transfer the flow of fluid out of the primary chamber. However, having flow channels of a fixed size will result in a same damping response for smoothing movement between two vehicle components, and therefore, cannot provide an effective real-time damping that adjusts to the particular vehicle conditions. Magnetorheological (MR) fluid may be used to variably control the flow of fluid out of the pressure chamber; however, with additional cost and design complexity.

### SUMMARY OF INVENTION

An advantage of an embodiment is a real-time variable control of the flow of fluid between a first chamber and a second chamber of a damping module by variably controlling a position of a damper in a damping assembly that couples two vehicle members. The variable control of the damper is controlled utilizing magnetic shape memory elements regulated by an electromagnetic field. The position of the damper may be regulated in real time to variably control the flow of fluid through an opening of a flow channel between the first chamber and the second chamber thereby controlling the relative movement or oscillation between two vehicle members. Another advantage of magnetic shape memory elements is the quick response time that allows for enhanced control of fluid flowing through the opening of the flow channel.

An embodiment contemplates a real-time continuous damping module. A cylindrical tubular member contains a fluid. The cylindrical tubular member includes a first chamber and a second chamber for receiving and storing fluid. A pressurizing device is configured to pressurize fluid in the first chamber. A flow channel is configured to allow fluid to flow between the first chamber and second chamber when the pressurizing device exerts a pressure on the fluid within the first chamber. A variable damper assembly is configured to control a flow of fluid through the flow channel. The variable damper assembly includes a damper configured to variably obstruct an opening of the flow channel. A magnetic shape memory element is configured to variably control a position of the damper within the opening of the flow channel. The magnetic shape memory element exhibits changes in shape when exposed to a magnetic field. An electromagnetic device is configured to generate the magnetic field across the magnetic shape memory element. The electromagnetic device regulates the magnetic field for variably controlling the position of the damper within the flow channel by changing the shape of the magnetic shape memory element.

### BRIEF DESCRIPTION OF DRAWINGS

FIG. 1 is a perspective view of a real time continuous damping module.

FIG. 2 is a schematic cross-section view of the variable damper assembly in a non-excited state.

FIG. 3 is a schematic cross-section view of the variable damper assembly in an excited state.

### DETAILED DESCRIPTION

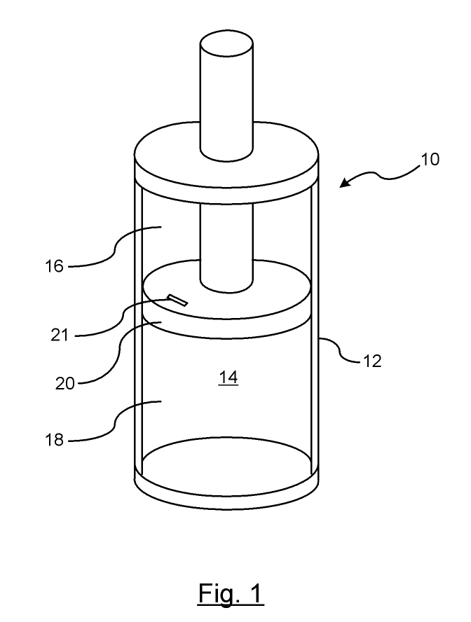

There is shown generally in FIG. 1 a real-time continuous damping module 10 that dampens shock or oscillation impulses between two vehicle members. The real-time continuous damping module 10 regulates the shock or oscillation transferred by one of the vehicle members by absorbing the impulses and dissipating the kinetic energy.

The real-time continuous damping module 10 includes a cylindrical tubular member 12 containing a fluid 14. The cylindrical tubular member 12 may be a single-tube construction or may be a twin-tube construction where the two tubes slide axially relative to one another. The cylindrical tubular member 12 includes a first chamber 16 and a second chamber 18 for retaining the fluid 14. The fluid 14 is pressurized in the first chamber 16 and is forced to the second chamber 18 that functions as a reservoir. The transition of the fluid from the first chamber 16 to the second chamber 18 affects the stiffness or compression force between the two vehicle components. By variably regulating the amount of fluid that is able to flow out of the first chamber 16 to the second chamber 18 when the first chamber is pressurized, the damping between the two components may be variably controlled.

A variable damper assembly 20 is disposed within the cylindrical tubular member 12 for controlling a flow of fluid through a flow channel 21 between the first chamber 16 and the second chamber 18. More than one flow channel may be incorporated within the variable damper assembly 20. The variable damper assembly 20 may be incorporated as part of a pressurizing device acting on the first chamber 16, such as a piston, or may be separate from the pressurizing device.

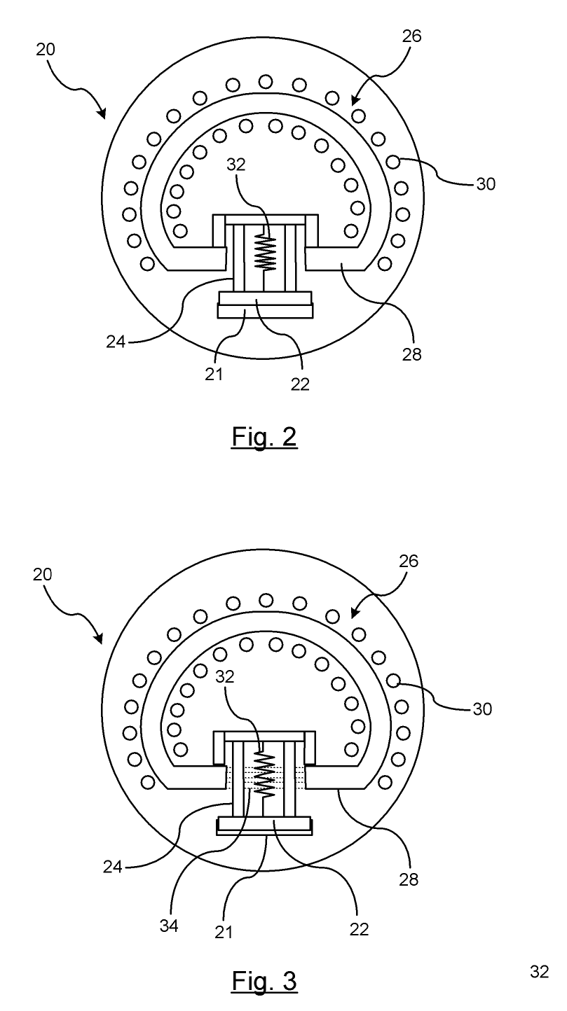

FIGS. 2 and 3 illustrate the variable damper assembly 20 in a non-excited state and an excited state, respectively. The flow channel 21 includes a conduit for allowing fluid flow between the first chamber 16 and the second chamber 18 (shown in FIG. 1). The variable damper assembly 10 includes a damper 22 configured to obstruct an opening of the flow channel 21. The damper 22 slidingly engages the opening of the flow channel 21. The damper 22 may be slidingly positioned over the opening of the flow channel 21 at any position between a fully unobstructed position and a fully obstructed position. The damper 22 includes a sectional area that can obstruct all of the opening of the flow channel 21 when in the fully obstructed position or can be variably positioned relevant to the opening to obstruct a portion of the opening. It should be understood that the damper may be displaced relative to the opening of the flow channel using other types of movement other than a sliding motion (e.g., pivoting damper).

A magnetic shape memory element 24 is configured to act on the damper 22 to control a position of the damper 22 relative to the opening of the flow channel 21. The magnetic shape memory element 24 exhibits changes in its shape when exposed to a magnetic field for variably displacing the damper 22 over the opening of the flow channel 21.

The variable damper assembly 20 further includes an electromagnetic device 26 that is configured for generating a magnetic field across the magnetic shape memory element 24. The electromagnetic device 26 includes a core 28, such as a ferromagnetic core, and a coil 30 wound around the core 28 for generating the magnetic field. The strength of the magnetic field depends on the current supplied to the coil 30, in addition to the cross-section area of the core 28, and the number of turns and the cross-section area of the wire of the coil 30. Varying the strength of the magnetic field generated by the electromagnetic device 26 will vary the expansion of the magnetic shape memory element 24.

FIG. 2 illustrates the magnetic shape memory element 24 at a non-excited position. When no current is applied to the electromagnetic device 26, the magnetic shape memory element 24 relaxes. A bias spring 32 is coupled to the damper 22 for maintaining a biasing force on the damper 22 when no magnetic field present for returning the damper 22 and magnetic shape memory element 24 to their original. The bias spring 32 may be pre-loaded so that the bias spring 32 maintains the damper 22 in an initial position when no magnetic field is applied to the magnetic shape memory element 24.

FIG. 3 illustrates a magnetic field 34 generated by the electromagnetic device 26 that is applied to the magnetic shape memory element 24 for limiting the flow of fluid through the opening of the flow channel 21 by the damper 22. As described earlier, the strength of the magnetic field 34 is dictated by the amount of current applied to the electromagnetic device 26. The strength of the magnetic field 34, in turn, determines the degree as to how much the magnetic shape memory element 24 is displaced. The magnetic shape memory element 24 produces a strain and expands when a magnetic field 34 is applied. The greater the strength of the magnetic field 34, the greater the expansion of the magnetic shape memory element 24. That is, the magnetic field is proportional to the strain of the magnetic shape memory elements. As a result, the magnetic field 34 is variably regulated in real time for variably controlling the expansion of the magnetic shape memory element 24 which directly controls the position of the damper 22 relative to the opening of the flow channel 21. Moreover, the magnetic shape memory element has a quick response time that allows for enhanced control of fluid flowing through the opening of the flow channel.

While certain embodiments of the present invention have been described in detail, those familiar with the art to which this invention relates will recognize various alternative designs and embodiments for practicing the invention as defined by the following claims.

What is claimed is:

1. A real-time continuous damping module comprising:
a cylindrical tubular member containing a fluid, the cylindrical tubular member including a first chamber and a second chamber for receiving and storing fluid;
a pressurizing device configured to pressurize fluid in the first chamber;
a flow channel configured to allow fluid to flow between the first chamber and second chamber when the pressurizing device exerts a pressure on the fluid within the first chamber; and
a variable damper assembly configured to control the flow of fluid through the flow channel, the variable damper assembly comprising:
a damper configured to variably obstruct an opening of the flow channel;
a magnetic shape memory element configured to variably control a position of the damper within the opening the flow channel, the magnetic shape memory element exhibiting changes in shape when exposed to a magnetic field; and
an electromagnetic device configured to generate the magnetic field across the magnetic shape memory element, the electromagnetic device regulating the magnetic field for variably controlling the position of the damper within the flow channel by changing the shape of the magnetic memory element.

2. The real-time continuous damping module of claim 1 wherein the damper slidingly engages the opening of the flow channel for variably controlling a size of the opening of the fluid channel.

3. The real-time continuous damping module of claim 1 wherein the magnetic shape memory element operatively engages the damper for engaging the damper over the opening, wherein magnetic shape memory element expands for variably displacing the damper over the opening, the variable displacement of the damper over the opening variably decreases a size of the opening of the fluid channel.

4. The real-time continuous damping module of claim 3 wherein the magnetic field is regulated for variably expanding a size of the magnetic shape memory element.

5. The real-time continuous damping module of claim 4 further comprising a bias spring, wherein the bias spring is a tension spring for maintaining a tension on the damper, wherein the strength of the magnetic field applied to the magnetic shape memory element overcomes a bias of the tension spring for variably positioning the damper over the opening of the fluid channel for controlling the flow of fluid through the opening.

6. The real-time continuous damping module of claim 1 wherein the variable damper assembly includes a plurality of magnetic memory shape elements.

7. The real-time continuous damping module of claim 1 wherein the electromagnetic device includes an electromagnetic coil and a core, wherein the electromagnetic coil is wound around the core.

8. The real-time continuous damping module of claim 1 wherein the pressurizing device includes a piston slidingly disposed within the cylindrical tubular member.

9. The real-time continuous damping module of claim 1 wherein the first chamber is a pressure chamber and the second chamber is a reservoir for retaining fluid forced out of the first chamber through the flow channel.

10. The real-time continuous damping module of claim 1 wherein a plurality of flow channels are formed within the variable damper assembly, wherein the flow of fluid through each flow channel is regulated by a respective damper that is controlled by a respective memory shape magnetic element excited by the magnetic field.
